(19) United States
(12) Patent Application Publication
(10) Pub. No.: US 2024/0414667 A1
(43) Pub. Date: Dec. 12, 2024

(54) METHOD OF REQUESTING AND DELIVERY OF SIB9 BASED ACCURATE TIME SYNCHRONIZATION VIA SIDELINK RELAY USER EQUIPMENT

(71) Applicant: Nokia Technologies Oy, Espoo (FI)

(72) Inventors: Thomas Haaning JACOBSEN, Aalborg (DK); Jakob Lindbjerg BUTHLER, Aalborg (DK); Pilar ANDRÉS MALDONADO, Aalborg (DK); Renato Barbosa ABREU, Aalborg (DK); Jan Torst HVIID, Aalborg (DK)

(21) Appl. No.: 18/701,917

(22) PCT Filed: Sep. 22, 2022
(86) PCT No.: PCT/EP2022/076358

§ 371 Date: Apr. 16, 2024

Related U.S. Application Data
(60) Provisional application No. 63/270,528, filed on Oct. 21, 2021.

(51) Int. Cl. H04W 56/00; H04W 72/40; H04W 76/14; H04W 88/04

(52) U.S. Cl. CPC H04W 56/0015; H04W 72/40; H04W 76/14; H04W 88/04

(57) ABSTRACT

Systems, methods, apparatuses, and computer program products for carrying information elements containing timing information to a remote user equipment via a relay UE. One method may include a relay user equipment receiving a system information block associated with reference time information from a network entity, and determining that a remote user equipment needs the reference time information. The method may further include transmitting the system information block to the remote user equipment according to at least one rule associated with the reference time information.

### TECHNICAL FIELD

Some example embodiments may generally relate to mobile or wireless telecommunication systems, such as Long Term Evolution (LTE), fifth generation (5G) radio access technology (RAT), new radio (NR) access technology, and/or other communications systems. For example, certain example embodiments may relate to systems and/or methods for carrying information elements containing timing information to a remote user equipment via a relay user equipment (UE).

### BACKGROUND

Examples of mobile or wireless telecommunication systems may include radio frequency (RF) 5G RAT, the Universal Mobile Telecommunications System (UMTS) Terrestrial Radio Access Network (UTRAN), LTE Evolved UTRAN (E-UTRAN), LTE-Advanced (LTE-A), LTE-A Pro, NR access technology, and/or MulteFire Alliance. 5G wireless systems refer to the next generation (NG) of radio systems and network architecture. A 5G system is typically built on a 5G NR, but a 5G (or NG) network may also be built on E-UTRA radio. It is expected that NR can support service categories such as enhanced mobile broadband (eMBB), ultra-reliable low-latency-communication (URLLC), and massive machine-type communication (mMTC). NR is expected to deliver extreme broadband, ultra-robust, low-latency connectivity, and massive networking to support the Internet of Things (IoT). The next generation radio access network (NG-RAN) represents the RAN for 5G, which may provide radio access for NR, LTE, and LTE-A. It is noted that the nodes in 5G providing radio access functionality to a user equipment (e.g., similar to the Node B in UTRAN or the Evolved Node B (eNB) in LTE) may be referred to as next-generation Node B (gNB) when built on NR radio, and may be referred to as next-generation eNB (NG-eNB) when built on E-UTRA radio.

### SUMMARY

In accordance with some example embodiments, a method may include receiving, by a relay user equipment, a system information block associated with reference time information from a network entity. The method may further include determining, by the relay user equipment, that a remote user equipment needs the reference time information. The method may further include transmitting, by the relay user equipment, the system information block to the remote user equipment according to at least one rule associated with the reference time information.

In accordance with certain example embodiments, an apparatus may include means for receiving a system information block associated with reference time information from a network entity. The apparatus may further include means for determining that a remote user equipment needs the reference time information. The apparatus may further include means for transmitting the system information block to the remote user equipment according to at least one rule associated with the reference time information.

In accordance with various example embodiments, a non-transitory computer readable medium may be encoded with instructions that may, when executed in hardware, perform a method. The method may include receiving a system information block associated with reference time information from a network entity. The method may further include determining that a remote user equipment needs the reference time information. The method may further include transmitting the system information block to the remote user equipment according to at least one rule associated with the reference time information.

In accordance with some example embodiments, a computer program product may perform a method. The method may include receiving a system information block associated with reference time information from a network entity. The method may further include determining that a remote user equipment needs the reference time information. The method may further include transmitting the system information block to the remote user equipment according to at least one rule associated with the reference time information.

In accordance with certain example embodiments, an apparatus may include at least one processor and at least one memory including computer program code. The at least one memory and the computer program code may be configured to, with the at least one processor, cause the apparatus to at least receive a system information block associated with reference time information from a network entity. The at least one memory and the computer program code may be further configured to, with the at least one processor, cause the apparatus to at least determine that a remote user equipment needs the reference time information. The at least one memory and the computer program code may be further configured to, with the at least one processor, cause the apparatus to at least transmit the system information block to the remote user equipment according to at least one rule associated with the reference time information.

In accordance with various example embodiments, an apparatus may include circuitry configured to receive a system information block associated with reference time information from a network entity. The circuitry may further be configured to determine that a remote user equipment needs the reference time information. The circuitry may further be configured to transmit the system information block to the remote user equipment according to at least one rule associated with the reference time information.

In accordance with some example embodiments, a method may include transmitting, by a remote user equipment, a request to receive reference time information to a relay user equipment. The method may further include receiving, by the remote user equipment, the system information block with additional information elements or a modified system information block.

In accordance with certain example embodiments, an apparatus may include means for transmitting a request to receive reference time information to a relay user equipment. The apparatus may further include means for receiving the system information block with additional information elements or a modified system information block.

In accordance with various example embodiments, a non-transitory computer readable medium may be encoded with instructions that may, when executed in hardware, perform a method. The method may include determining scheduling high priority timing constraints. The method may further include transmitting a modified system information block with normal or high priority physical sidelink shared channel transmission.

In accordance with some example embodiments, a computer program product may perform a method. The method may include determining scheduling high priority timing constraints. The method may further include transmitting a modified system information block with normal or high priority physical sidelink shared channel transmission.

In accordance with certain example embodiments, an apparatus may include at least one processor and at least one memory including computer program code. The at least one memory and the computer program code may be configured to, with the at least one processor, cause the apparatus to at least determine scheduling high priority timing constraints. The at least one memory and the computer program code may be further configured to, with the at least one processor, cause the apparatus to at least transmit a modified system information block with normal or high priority physical sidelink shared channel transmission.

In accordance with various example embodiments, an apparatus may include circuitry configured to determine scheduling high priority timing constraints. The circuitry may further be configured to transmit a modified system information block with normal or high priority physical sidelink shared channel transmission.

### BRIEF DESCRIPTION OF THE DRAWINGS

For proper understanding of example embodiments, reference should be made to the accompanying drawings, wherein:

FIG. 1 illustrates an example of system frame numbers.

FIG. 2 illustrates an example of SIB9 information elements.

FIG. 3 illustrates an example of a signaling diagram according to certain example embodiments.

FIG. 4 illustrates an example of a flow diagram of a method according to various example embodiments.

FIG. 5 illustrates an example of a flow diagram of a method according to various example embodiments.

FIG. 6 illustrates an example of various network devices according to some example embodiments.

FIG. 7 illustrates an example of a 5G network and system architecture according to certain example embodiments.

### DETAILED DESCRIPTION

It will be readily understood that the components of certain example embodiments, as generally described and illustrated in the figures herein, may be arranged and designed in a wide variety of different configurations. Thus, the following detailed description of some example embodiments of systems, methods, apparatuses, and computer program products for carrying information elements containing timing information to a remote UE via a relay UE is not intended to limit the scope of certain example embodiments, but is instead representative of selected example embodiments.

Third Generation Partnership Project (3GPP) Release (Rel)-16 introduced accurate time synchronization with support of time sensitive networking (TSN) for industrial communication purposes. 3GPP Rel-17 extended the purpose of accurate time synchronization to cover use cases other than Industrial Internet of Things (IIoT) for use in wide-area deployments suitable for power meters, payment terminals, vehicles, etc. With the help of accurate time synchronization, a UE may acquire an accurate time of day (ToD) relative to a global time domain (e.g., Universal Coordinated Time (UTC)). This may be used directly as a function for how the device behaves (e.g., robots coordinating their actions, or executing at specific time instances), or alternatively, to timestamp events (packets, actions, transactions, etc.) to determine a global order of events, which may be critical for bitcoin generation and financial transactions.

Accurate 5G System (5GS) time synchronization may be enabled with a framework having two aspects: First, specific events may be identified at the air interface, timestamping these events at the gNB, and then the UE may identify these events and receive the timestamp relative to these events from the gNB to acquire a ToD. Second, accurate 5GS time synchronization may further include mechanisms for the propagation delay compensation (PDC).

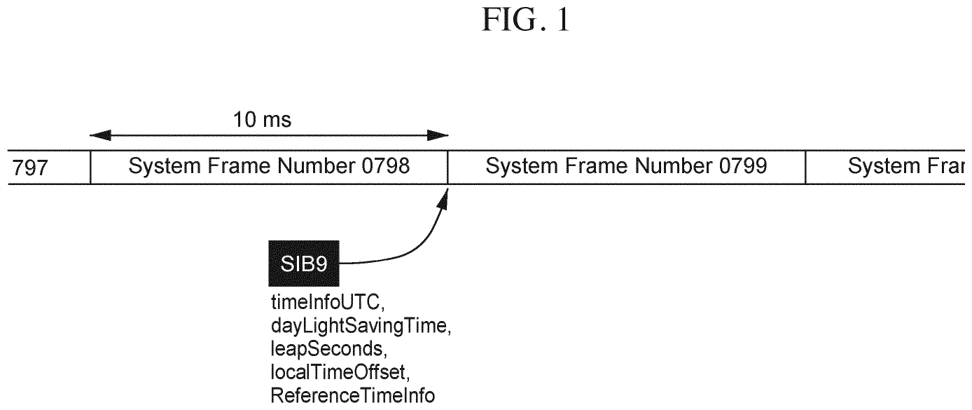

With respect to identifying specific events at the air interface, the air interface event timestamped by the gNB may be an ending boundary of a reference system frame number (SFN), as shown in FIG. 1. The timestamp may be carried in a ReferenceTimeInfo-r16 information element (RTI) that may be transmitted in a SIB9 (e.g., for broadcasting) and/or RTI may be delivered via dedicated radio resource control (RRC) signalling as a part of DLInformationTransfer. For RRC carrying RTI, the reference SFN that the timestamp refers to may be provided explicitly (can be back or forth in time), or, in case of SIB9 carrying RTI, the reference SFN may be implicitly given by the SFN in which the ongoing system information window (SI-window) may end.

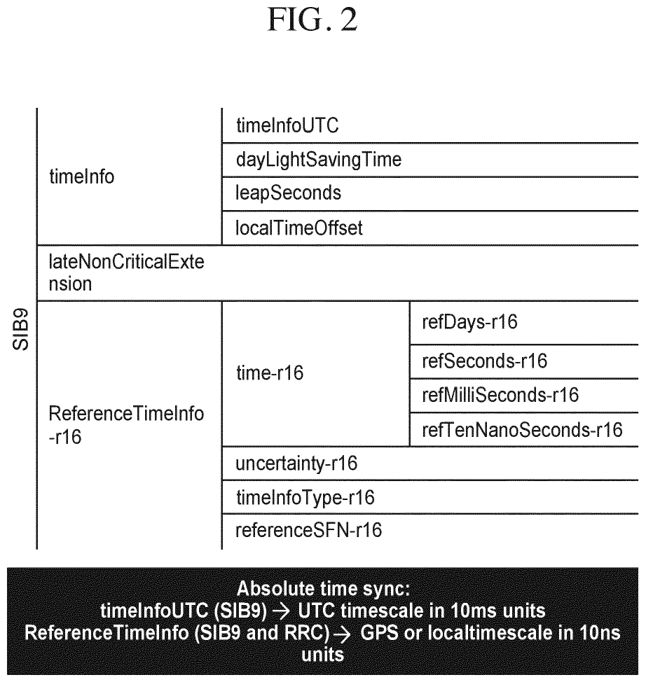

As shown in FIG. 2, SIB9 may consist of a main IE (timeInfo), and an RTI IE extension. The gNB may include RTI IE in SIB9. However, the gNB may become aware that it should transmit RTI to the UEs if preconfigured by the core network to always deliver RTI and/or to always deliver RTI to particular UEs. Alternatively, the UE may request a timestamp (e.g., RTI) via, for example, a ReferenceTimeInfoPreference field in the UEAssistanceInformation IE.

Sidelink (SL) communications may extend coverage by allowing UEs that are out of normal gNB coverage to be serviced. For example, with 3GPP Rel-16, a first version of NR SL supports V2X related services, while Rel-17 provides further coverage extensions for sidelink-based communication, such as UE-to-network (U2N) coverage extension and UE-to-UE coverage extension in 3GPP Rel-18. In order to support UE-to-NW relays, it has been agreed to enable SIB forwarding in order to allow a remote UE to obtain system information from the network.

When forwarding SIBs in SL, the SIB9 used to provide time information may include, for example, time information references to an air interface event at the Uu interface (gNB-to-UE). However, the forwarded information may be consumed at a remote UE that communicates via PC5 interface (UE-to-UE). As a result, the remote UE may be unable to indicate (to the gNB or relay UE) that it wants SIB9 including a timestamp (e.g., ReferenceTimeInfo (i.e., 3GPP Rel-16)). Additionally or alternatively, if the UE requests SIB9, the UE may risk receiving a SIB9 without the timestamp (e.g., ReferenceTimeInfo (i.e., 3GPP Rel-15)), thus disabling the opportunity for accurate time information synchronization available from 3GPP Rel-16. Furthermore, receiving SIB9 with non-altered information may leave the remote UE without instructions on how to proceed despite receiving information in the request.

Certain example embodiments described herein may have various benefits and/or advantages to overcome the disadvantages described above. For example, certain example embodiments may enable accurate time synchronization via a sidelink interface to devices that are out of coverage, or within coverage via a nearby relay UE (e.g., to conserve power). Thus, certain example embodiments discussed below are directed to improvements in computer-related technology.

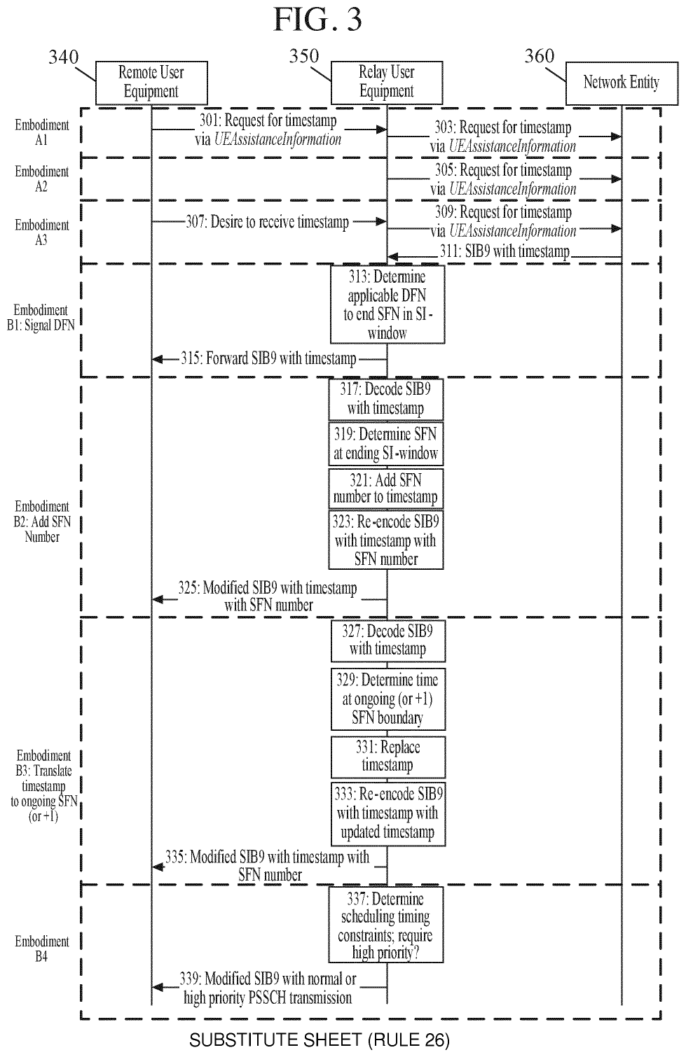

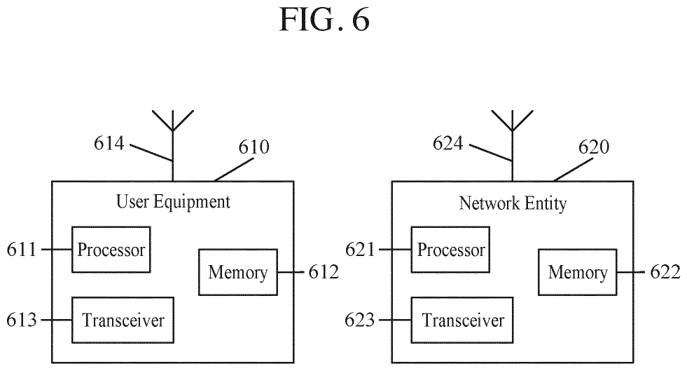

FIG. 3 illustrates an example of a signaling diagram depicting carrying an IE, such as a timestamp (e.g., ReferenceTimeInfo) IE, on SIB9 to a remote UE via a relay UE. Remote UE 340, relay UE 350, and NE 360 may be similar to UE 610 and NE 620, respectively, as illustrated in FIG. 6, according to certain example embodiments.

Remote UE 340 may indicate a request for a 3GPP Rel-16 SIB9 which may also carry the timestamp (e.g., ReferenceTimeInfo). Specifically, relay UE 350 may receive and forward the timestamp to remote UE 340, while NE 360 may determine whether the timestamp is transmitted in a SIB9 or via RRC. For example, at 301, remote UE 340 may transmit to relay UE 350 a request for the timestamp (e.g., ReferenceTimeInfoPreference) information via a UEAssistanceInformation IE, which may be forwarded by relay UE 350 to NE 360 at 303 via RRC signaling.

In various example embodiments, relay UE 350 may have a default operation to request accurate timing information (e.g., 3GPP Rel-16 with RTI) when a connected remote UE, such as remote UE 340, requests SIB9. This may be advantageous when voluntary forwarding is supported, and/or when no direct signaling to request SIB9 with the timestamp is supported by remote UE 340. For example, at 305, relay UE 350 may transmit a timestamp (e.g., RTI), via, for example, a ReferenceTimeInfoPreference field via a UEAssistanceInformation IE to NE 360 based on a configuration transmitted from remote UE 340 to relay UE 350, such as a UE capability transfer during connection setup, during the relay establishment, and/or indicated in a discovery message. Additionally or alternatively, relay UE 350 may be configured to respond as to whether relay UE 350 accepts forwarding of SIB9 with a timestamp (e.g., ReferenceTimeInfo), as well as configurations for delivery of SIB9 with the timestamp.

In some example embodiments, at 307, remote UE 340 may transmit to relay UE 350 a request to receive a timestamp (e.g., ReferenceTimeInfo) (e.g., in the indication to request SIB9 forwarding), which may be forwarded by relay UE 350 to NE 360. This indication may also include a preferred/desired periodicity of receiving ReferenceTimeInfo. Remote UE 340 may inform a required periodicity and/or holdover capability, and/or clock accuracy (e.g., in PPM), and/or required timing accuracy. Relay UE 350 may forward (e.g., via RRC) this information to NE 360 so that NE 360 may take a decision on serving periodicity of timing information to remote UE 340 via relay UE 350 and/or relay UE 350 may also take a decision on periodicity of forwarding the timing info to remote UE 340, based on the information. Similarly, at remote UE 340 may transmit the ReferenceTimeInfoPreference through UEAssistanceInformation to relay UE 350, which may set to true its own ReferenceTimeInfoPreference and forward to NE 360 at 309. At 311, NE 360 may transmit an SIB9 with ReferenceTimeInfo to relay UE 350, enabling remote UE 340 to understand ReferenceTimeInfo carried via RRC and/or SIB9, as follows.

In certain example embodiments, at 313, relay UE 350 may translate (i.e., determine) the SFN where the SI-window ends at the corresponding DFN boundary (starting or ending). At 315, relay UE 350 may then transmit this DFN number to remote UE 340 (e.g., via a new IE). SIB9 with ReferenceTimeInfo may also be relayed to remote UE 340. As an example, the SFN in the RTI may be read by remote UE 340 as a DFN.

In various example embodiments, at 317, relay UE 350 may decode the SIB9 received from NE 360 with ReferenceTimeInfo. At 319, relay UE 350 may determine an SFN at the end of an SI-window. At 321, relay UE 350 may add the SFN number where the SI-window ends at the ReferenceTimeInfo. Specifically, relay UE 350 may translate ReferenceTimeInfo from the SIB9 version into an RRC version including refSFN for the sidelink (e.g., refDFN). At 323, relay UE 350 may re-encode SIB9 with ReferenceTimeInfo with the SFN number, and at 325, a modified SIB9 with ReferenceTimeInfo may be transmitted to remote UE 340 by relay UE 350.

In some example embodiments, at 327, relay UE 350 may decode the SIB9 with ReferenceTimeInfo. At 329, relay UE 350 may determine a time at an ongoing (or +1) SFN boundary, and at 331, may replace the timestamp in ReferenceTimeInfo. Relay UE 350 may determine the need for normal/high priority delivery of SIB9 over the PC5 interface. For example, high priority may be needed to transmit SIB9 to remote UE 340 in sufficient time to determine the timestamp with the corresponding air interface event. Relay UE 350 may translate the timestamp to be applicable for the current or next DFN boundary. This may depend on the timing of delivery of SIB9 whether the relay UE 350 would use the current or the next one (or a later one). A rule may be used by relay UE 350 and remote UE 340 to enable them to agree on which DFN boundary is referred based on at least the transmission/reception of ReferenceTimeInfo over PC5. At 333, relay UE 350 may re-encode SIB9 with ReferenceTimeInfo with the SFN number. At 335, relay UE 350 may transmit a modified SIB9 with ReferenceTimeInfo with the needed scheduling priority.

At 337, relay UE 350 may determine scheduling timing constraints, and may require high priority, and at 339, may transmit a modified SIB9 with normal or high priority PSSCH transmission.

Some example embodiments may include legacy timing information, i.e., timeInfo in SIB9 which may carry timeInfoUTC, since it may also correspond to the SFN boundary at or immediately after the ending boundary of the SI-window in which SIB9 is transmitted. Thus, relay UE 350 may modify/add the translation of SFN boundary to a DFN boundary in the timeInfo IE.

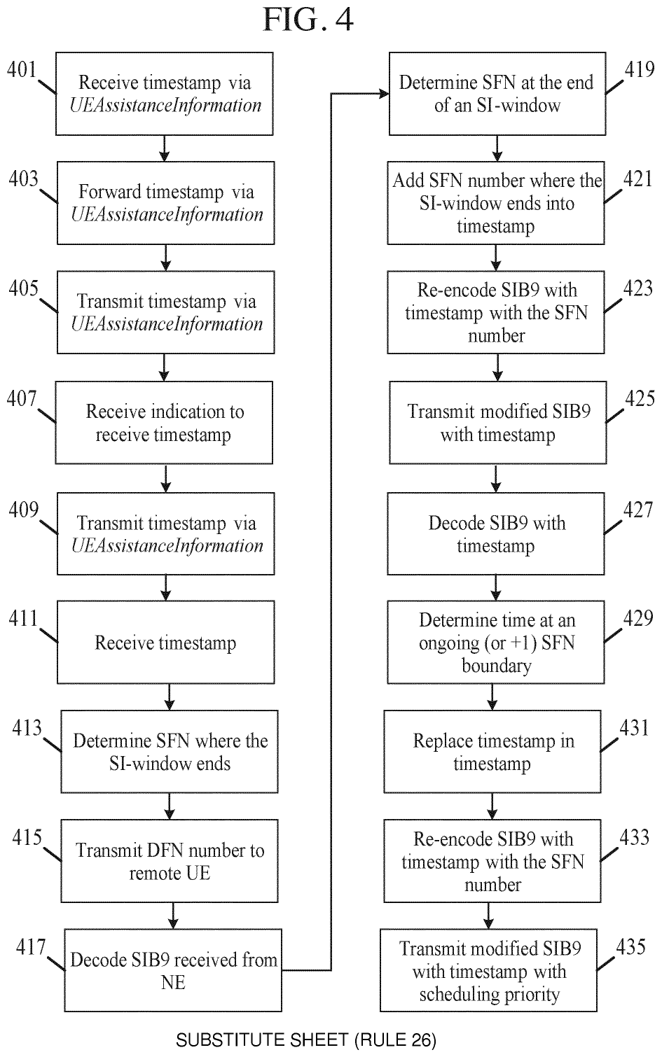

FIG. 4 illustrates an example of a flow diagram of a method that may be performed by a relay UE, such as UE 610 illustrated in FIG. 6, according to various example embodiments. A remote UE may request a 3GPP Rel-16 SIB9 which also carries ReferenceTimeInfo. For example, at 401, the relay UE may receive ReferenceTimeInfoPreference information via a UEAssistanceInformation IE from a remote UE (such as UE 610 illustrated in FIG. 6), which may then be forwarded to a NE at 403 via RRC signaling.

In various example embodiments, the relay UE may have a default operation to request SIB9 (e.g., 3GPP Rel-16 with RTI) when the connected remote UE requests SIB9. This may be advantageous when voluntary forwarding is supported, and/or when no direct signaling to request SIB9 with ReferenceTimeInfo is supported. For example, at 405, the relay UE may transmit ReferenceTimeInfoPreference information via a UEAssistanceInformation IE to the NE based on a configuration transmitted from the remote UE to the relay UE, such as a UE capability transfer during connection setup, during the relay establishment, and/or indicated in a discovery message. Additionally or alternatively, the relay UE may be configured to respond as to whether the relay UE accepts forwarding of SIB9 with ReferenceTimeInfo, as well as configurations for delivery of SIB9 with ReferenceTimeInfo.

In some example embodiments, at 407, the relay UE may receive an indication to receive ReferenceTimeInfo (e.g., to request SIB9 forwarding), which may be forwarded by the relay UE to the NE. This indication may also include a requested periodicity of receiving ReferenceTimeInfo. The remote UE may inform a required periodicity and/or holdover capability, and/or clock accuracy (e.g., in PPM), and/or required timing accuracy. The relay UE may forward (e.g., via RRC) this information to the NE so that the NE may take a decision on serving periodicity of timing information to the remote UE via the relay UE and/or the relay UE may also take a decision on periodicity of forwarding the timing info to the remote UE, based on the information.

Similarly, at 409, the relay UE may set to true its own Reference TimeInfoPreference and forward to the NE. At 411, the relay UE may receive an SIB9 with ReferenceTimeInfo, enabling the remote UE to understand ReferenceTimeInfo carried via RRC and/or SIB9, as follows.

In certain example embodiments, at 413, the relay UE may translate (i.e., determine) the SFN where the SI-window ends at the corresponding DFN boundary (starting or ending). At 415, the relay UE may then transmit this DFN number to the remote UE (e.g., via a new IE). SIB9 with ReferenceTimeInfo may also be relayed to the remote UE. As an example, the SFN in the RTI may be read by remote UE 340 as a DFN.

In various example embodiments, at 417, the relay UE may decode the SIB9 received from the NE with ReferenceTimeInfo. At 419, the relay UE may determine an SFN at the end of an SI-window. At 421, the relay UE may add the SFN number where the SI-window ends at the ReferenceTimeInfo. Specifically, the relay UE may translate ReferenceTimeInfo from the SIB9 version into an RRC version including refSFN (e.g., refDFN). At 423, the relay UE may re-encode SIB9 with ReferenceTimeInfo with the SFN number, and at 425, a modified SIB9 with ReferenceTimeInfo may be transmitted to the remote UE.

In some example embodiments, at 427, the relay UE may decode the SIB9 with ReferenceTimeInfo. At 429, the relay UE may determine a time at an ongoing (or +1) SFN boundary, and at 431, may replace the timestamp in ReferenceTimeInfo. The relay UE may determine the need for normal/high priority delivery of SIB9 over the PC5 interface. For example, high priority may be needed to transmit SIB9 to the remote UE in sufficient time to determine the timestamp with the corresponding air interface event. The relay UE may translate the timestamp to be applicable for the current or next DFN boundary. This may depend on the timing of delivery of SIB9 whether the relay UE would use the current or the next one (or a later one). A rule may be used by the relay UE and the remote UE to enable them to agree on which DFN boundary is referred based on at least the transmission/reception of ReferenceTimeInfo over PC5. At 433, the relay UE may re-encode SIB9 with ReferenceTimeInfo with the SFN number. At 435, the relay UE may transmit a modified SIB9 with ReferenceTimeInfo with the needed scheduling priority. Furthermore, the relay UE may determine scheduling timing constraints, and may require high priority, and may transmit a modified SIB9 with normal or high priority PSSCH transmission.

Some example embodiments may include legacy timing information, i.e., timeInfo in SIB9 which carries timeInfoUTC, since it may also correspond to the SFN boundary at or immediately after the ending boundary of the SI-window in which SIB9 is transmitted. Thus, instead of modifying the ReferenceTimeInfo, the relay UE may modify/add the translation of SFN boundary to a DFN boundary in the timeInfo IE.

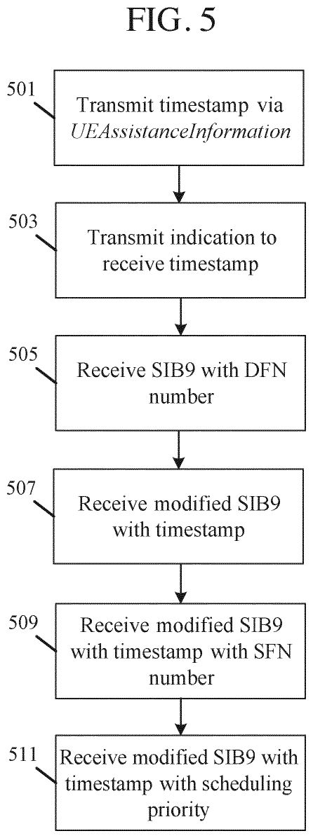

FIG. 5 illustrates an example of a flow diagram of a method that may be performed by a remote UE, such as UE 610 illustrated in FIG. 6, according to various example embodiments. A remote UE may request a 3GPP Rel-16 SIB9 which also carries ReferenceTimeInfo. For example, at 501, the remote UE may transmit ReferenceTimeInfoPreference information via a UEAssistanceInformation IE from a relay UE (such as UE 610 illustrated in FIG. 6), which may be forwarded to a NE.

In some example embodiments, at 503, the remote UE may transmit an indication to receive ReferenceTimeInfo (e.g., to request SIB9 forwarding), which may be forwarded by the relay UE to the NE. This indication may also include a requested periodicity of receiving ReferenceTimeInfo. The remote UE may inform a required periodicity and/or holdover capability, and/or clock accuracy (e.g., in PPM), and/or required timing accuracy. The relay UE may forward (e.g., via RRC) this information to the NE so that the NE may take a decision on serving periodicity of timing information to the remote UE via the relay UE and/or the relay UE may also take a decision on periodicity of forwarding the timing info to the remote UE, based on the information.

In certain example embodiments, at 505, the remote UE may receive a DFN number from the relay UE (e.g., via a new IE). SIB9 with ReferenceTimeInfo may also be received by the relay UE. The relay UE may translate (i.e., determine) the SFN where the SI-window ends at the corresponding DFN boundary (starting or ending).

In various example embodiments, at 507, the remote UE may receive a modified SIB9 with ReferenceTimeInfo from the relay UE. For example, the relay UE may decode the SIB9 received from the NE with ReferenceTimeInfo. The relay UE may determine an SFN at the end of an SI-window, and may add the SFN number where the SI-window ends at the ReferenceTimeInfo. Specifically, the relay UE may translate ReferenceTimeInfo from the SIB9 version into an RRC version including refSFN (e.g., refDFN). The relay UE may re-encode SIB9 with ReferenceTimeInfo with the SFN number.

In some example embodiments, at 509, the remote relay UE may receive a modified SIB9 with ReferenceTimeInfo with a needed scheduling priority. The relay UE may decode the SIB9 with ReferenceTimeInfo. The relay UE may determine a time at an ongoing (or +1) SFN boundary, and replace the timestamp in ReferenceTimeInfo. The relay UE may determine the need for normal/high priority delivery of SIB9 over the PC5 interface. For example, high priority may be needed to transmit SIB9 to the remote UE in sufficient time to determine the timestamp with the corresponding air interface event. The relay UE may translate the timestamp to be applicable for the current or next DFN boundary. This may depend on the timing of delivery of SIB9 whether the relay UE would use the current or the next one (or a later one). A rule may be used by the relay UE and the remote UE to enable them to agree on which DFN boundary is referred based on at least the transmission/reception of ReferenceTimeInfo over PC5. The relay UE may re-encode SIB9 with ReferenceTimeInfo with the SFN number.

At 511, the remote UE may receive a modified SIB9 with normal or high priority PSSCH transmission. The relay UE may determine scheduling timing constraints, and may require high priority.

Some example embodiments may include legacy timing information, i.e., timeInfo in SIB9 which carries timeInfoUTC, since it may also correspond to the SFN boundary at or immediately after the ending boundary of the SI-window in which SIB9 is transmitted. Thus, instead of modifying the ReferenceTimeInfo, the relay UE may modify/add the translation of SFN boundary to a DFN boundary in the timeInfo IE.

FIG. 6 illustrates an example of a system according to certain example embodiments. In one example embodiment, a system may include multiple devices, such as, for example, UE 610 and/or NE 620.

UE 610 may include one or more of a mobile device, such as a mobile phone, smart phone, personal digital assistant (PDA), tablet, or portable media player, digital camera, pocket video camera, video game console, navigation unit, such as a global positioning system (GPS) device, desktop or laptop computer, single-location device, such as a sensor or smart meter, or any combination thereof.

UE 610 may be one or more of a base station, such as an eNB or gNB, a serving gateway, a server, and/or any other access node or combination thereof. Furthermore, UE 610 and/or NE 620 may be one or more of a citizens broadband radio service device (CBSD).

NE 620 may further comprise at least one gNB-CU, which may be associated with at least one gNB-DU. The at least one gNB-CU and the at least one gNB-DU may be in communication via at least one F1 interface, at least one Xₙ-C interface, and/or at least one NG interface via a 5GC.

UE 610 and/or NE 620 may include at least one processor, respectively indicated as 611 and 621. Processors 611 and 621 may be embodied by any computational or data processing device, such as a central processing unit (CPU), application specific integrated circuit (ASIC), or comparable device. The processors may be implemented as a single controller, or a plurality of controllers or processors.

At least one memory may be provided in one or more of the devices, as indicated at 612 and 622. The memory may be fixed or removable. The memory may include computer program instructions or computer code contained therein. Memories 612 and 622 may independently be any suitable storage device, such as a non-transitory computer-readable medium. A hard disk drive (HDD), random access memory (RAM), flash memory, or other suitable memory may be used. The memories may be combined on a single integrated circuit as the processor, or may be separate from the one or more processors. Furthermore, the computer program instructions stored in the memory, and which may be processed by the processors, may be any suitable form of computer program code, for example, a compiled or interpreted computer program written in any suitable programming language.

Processors 611 and 621, memories 612 and 622, and any subset thereof, may be configured to provide means corresponding to the various blocks of FIGS. 3-5. Although not shown, the devices may also include positioning hardware, such as GPS or micro electrical mechanical system (MEMS) hardware, which may be used to determine a location of the device. Other sensors are also permitted, and may be configured to determine location, elevation, velocity, orientation, and so forth, such as barometers, compasses, and the like.

As shown in FIG. 6, transceivers 613 and 623 may be provided, and one or more devices may also include at least one antenna, respectively illustrated as 614 and 624. The device may have many antennas, such as an array of antennas configured for multiple input multiple output (MIMO) communications, or multiple antennas for multiple RATs. Other configurations of these devices, for example, may be provided. Transceivers 613 and 623 may be a transmitter, a receiver, both a transmitter and a receiver, or a unit or device that may be configured both for transmission and reception.

The memory and the computer program instructions may be configured, with the processor for the particular device, to cause a hardware apparatus, such as UE, to perform any of the processes described above (i.e., FIGS. 3-5). Therefore, in certain example embodiments, a non-transitory computer-readable medium may be encoded with computer instructions that, when executed in hardware, perform a process such as one of the processes described herein. Alternatively, certain example embodiments may be performed entirely in hardware.

In certain example embodiments, an apparatus may include circuitry configured to perform any of the processes or functions illustrated in FIGS. 3-5. For example, circuitry may be hardware-only circuit implementations, such as analog and/or digital circuitry. In another example, circuitry may be a combination of hardware circuits and software, such as a combination of analog and/or digital hardware circuitry with software or firmware, and/or any portions of hardware processors with software (including digital signal processors), software, and at least one memory that work together to cause an apparatus to perform various processes or functions. In yet another example, circuitry may be hardware circuitry and or processors, such as a microprocessor or a portion of a microprocessor, that includes software, such as firmware, for operation. Software in circuitry may not be present when it is not needed for the operation of the hardware.

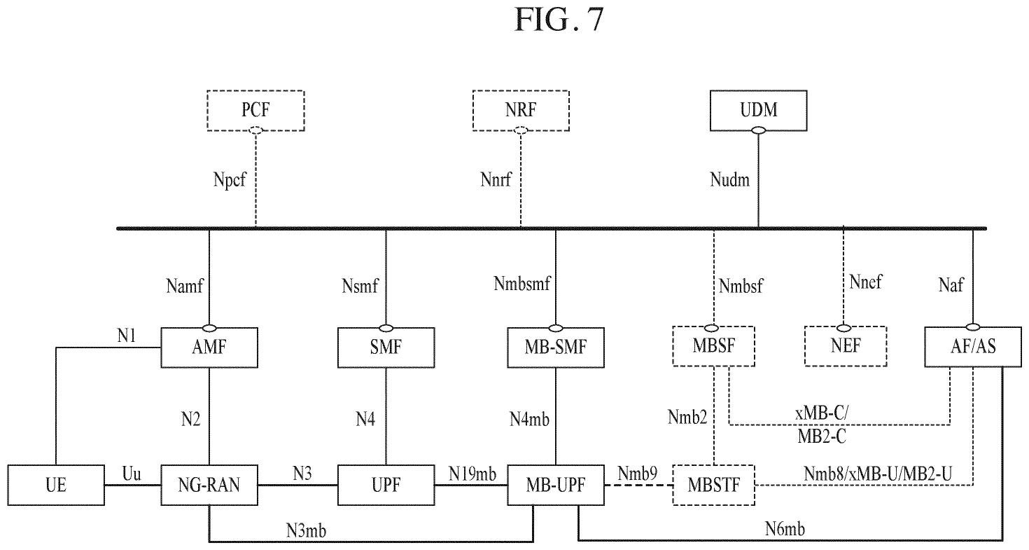

FIG. 7 illustrates an example of a 5G network and system architecture according to certain example embodiments. Shown are multiple network functions that may be implemented as software operating as part of a network device or dedicated hardware, as a network device itself or dedicated hardware, or as a virtual function operating as a network device or dedicated hardware. The UE and NE illustrated in FIG. 7 may be similar to UE 610 and NE 620, respectively. The user plane function (UPF) may provide services such as intra-RAT and inter-RAT mobility, routing and forwarding of data packets, inspection of packets, user plane quality of service (QoS) processing, buffering of downlink packets, and/or triggering of downlink data notifications. The application function (AF) may primarily interface with the core network to facilitate application usage of traffic routing and interact with the policy framework.

According to certain example embodiments, processor 611 and memory 612 may be included in or may form a part of processing circuitry or control circuitry. In addition, in some example embodiments, transceiver 513 may be included in or may form a part of transceiving circuitry.

In some example embodiments, an apparatus (e.g., apparatus 610 and/or apparatus 620) may include means for performing a method, a process, or any of the variants discussed herein. Examples of the means may include one or more processors, memory, controllers, transmitters, receivers, and/or computer program code for causing the performance of the operations.

The features, structures, or characteristics of example embodiments described throughout this specification may be combined in any suitable manner in one or more example embodiments. For example, the usage of the phrases “various embodiments,” “certain embodiments,” “some embodiments,” or other similar language throughout this specification refers to the fact that a particular feature, structure, or characteristic described in connection with an example embodiment may be included in at least one example embodiment. Thus, appearances of the phrases “in various embodiments,” “in certain embodiments,” “in some embodiments,” or other similar language throughout this specification does not necessarily all refer to the same group of example embodiments, and the described features, structures, or characteristics may be combined in any suitable manner in one or more example embodiments.

Additionally, if requested, the different functions or procedures discussed above may be performed in a different order and/or concurrently with each other. Furthermore, if requested, one or more of the described functions or procedures may be optional or may be combined. As such, the description above should be considered as illustrative of the principles and teachings of certain example embodiments, and not in limitation thereof.

One having ordinary skill in the art will readily understand that the example embodiments discussed above may be practiced with procedures in a different order, and/or with hardware elements in configurations which are different than those which are disclosed. Therefore, although some embodiments have been described based upon these example embodiments, it would be apparent to those of skill in the art that certain modifications, variations, and alternative constructions would be apparent, while remaining within the spirit and scope of the example embodiments.

### Partial Glossary

3GPP Third Generation Partnership Project
5G Fifth Generation
5GC Fifth Generation Core
5GS Fifth Generation System
AMF Access and Mobility Management Function
ASIC Application Specific Integrated Circuit
BS Base Station
CBSD Citizens Broadband Radio Service Device
CE Control Elements
CG Configured Grant
CN Core Network
CPU Central Processing Unit
CU Centralized Unit
DFN Direct Frame Number
DMRS Demodulation Reference Signal
eMBB Enhanced Mobile Broadband
eMTC Enhanced Machine Type Communication
eNB Evolved Node B
eOLLA Enhanced Outer Loop Link Adaptation
EPS Evolved Packet System
gNB Next Generation Node B
GPS Global Positioning System
HDD Hard Disk Drive
IE Information Element
IIoT Industrial Internet of Things
LTE Long-Term Evolution
LTE-A Long-Term Evolution Advanced
MEMS Micro Electrical Mechanical System
MIMO Multiple Input Multiple Output
mMTC Massive Machine Type Communication
MPDCCH Machine Type Communication Physical Downlink
Control Channel
NB-IoT Narrowband Internet of Things
NE Network Entity
NG Next Generation
NG-eNB Next Generation Evolved Node B
NG-RAN Next Generation Radio Access Network
NR New Radio
NR-U New Radio Unlicensed
PD Propagation Delay
PDA Personal Digital Assistance
PDC Propagation Delay Compensation
PSSCH Physical Sidelink Shared Channel
RAM Random Access Memory
RAN Radio Access Network
RAT Radio Access Technology
RRC Radio Resource Control
RTI Reference Time Information
SFN System Frame Number
SIB System Information Block
SL Sidelink
SMF Session Management Function
SSB Synchronization Signal Block
ToD Time of Day
TSN Time Sensitive Communications
U2N User Equipment-to-Network
UE User Equipment
UL Uplink
UMTS Universal Mobile Telecommunications System
UPF User Plane Function
URLLC Ultra-Reliable and Low-Latency Communication
UTC Coordinated Universal Time
UTRAN Universal Mobile Telecommunications System
Terrestrial Radio Access Network
V2X Vehicle-to-X
WLAN Wireless Local Area Network

1-51. (canceled)

52. A method, comprising:
receiving, by a relay user equipment, a system information block associated with reference time information from a network entity;
determining, by the relay user equipment, that a remote user equipment needs the reference time information; and
transmitting, by the relay user equipment, the system information block to the remote user equipment according to at least one rule associated with the reference time information.

53. The method of claim 52, further comprising:
receiving, by the relay user equipment, a configuration for receiving the reference time information; and
transmitting, by the relay user equipment, a reference time information preference to the network entity based on the configuration.

54. The method of claim 53, wherein the configuration comprises a static configuration for continuous forwarding.

55. The method of claim 53, wherein the configuration comprises a translation of the reference time information.

56. An apparatus, comprising:
at least one processor; and
at least one memory including computer program code,
wherein the at least one memory and the computer program code are configured to, with the at least one processor, cause the apparatus at least to:
receive a system information block associated with reference time information from a network entity;
determine that a remote user equipment needs the reference time information; and
transmit the system information block to the remote user equipment according to at least one rule associated with the reference time information.

57. The apparatus of claim 56, wherein the at least one memory and the computer program code are further configured to, with the at least one processor, cause the apparatus at least to:
receive a configuration for receiving the reference time information; and
transmit a reference time information preference to the network entity based on the configuration.

58. The apparatus of claim 56, wherein the configuration comprises a static configuration for continuous forwarding.

59. The apparatus of claim 56, wherein the configuration comprises a translation of the reference time information.

60. The apparatus of claim 56, wherein the at least one memory and the computer program code are further configured to, with the at least one processor, cause the apparatus at least to:
transmit to the remote user equipment at least one of an acceptance, a rejection, or an update of the configuration.

61. The apparatus of claim 56, wherein the at least one memory and the computer program code are further configured to, with the at least one processor, cause the apparatus at least to:
determine a system frame number where a system information window ends at a corresponding direct frame number boundary; and
transmit the direct frame number to the remote user equipment according to the at least one rule.

62. The apparatus of claim 56, wherein the at least one memory and the computer program code are further configured to, with the at least one processor, cause the apparatus at least to:
decode the system information block received from the network entity with reference time information;
determine a system frame number where a system information window ends at a corresponding direct frame number boundary;
add the direct frame number into the reference time information;
re-encode the system information block with reference time information with the direct frame number; and
transmit the re-encoded system information block to the remote user equipment according to the at least one rule.

63. The apparatus of claim 56, wherein the at least one memory and the computer program code are further configured to, with the at least one processor, cause the apparatus at least to:
decode the system information block received from the network entity with reference time information;
determine a time at an ongoing system frame number boundary into a corresponding direct frame number boundary;
replace a timestamp in reference time information;
re-encode the system information block with reference time information with the direct frame number; and
transmit the re-encoded system information block to the remote user equipment.

64. The apparatus of claim 56, wherein the at least one memory and the computer program code are further configured to, with the at least one processor, cause the apparatus at least to:
determine scheduling high priority timing constraints; and
transmit a modified system information block with normal or high priority physical sidelink shared channel transmission.

65. The apparatus of claim 56, wherein the at least one memory and the computer program code are further configured to, with the at least one processor, cause the apparatus at least to:
transmit at least one of a required periodicity, holdover capability, clock accuracy, or required timing accuracy.

66. An apparatus, comprising:
at least one processor; and
at least one memory including computer program code,
wherein the at least one memory and the computer program code are configured to, with the at least one processor, cause the apparatus at least to:
transmit a request to receive reference time information to a relay user equipment; and
receive the system information block with additional information elements or a modified system information block.

67. The apparatus of claim 66, wherein the at least one memory and the computer program code are further configured to, with the at least one processor, cause the apparatus at least to:
receive a direct frame number from the relay user equipment that is associated to a received reference time information.

68. The apparatus of claim 66, wherein the modified system information block comprises a direct frame number where a system information window ends at the reference time information.

69. The apparatus of claim 66, wherein the modified system information block is associated with a time at an ongoing direct frame number boundary.

70. The apparatus of claim 66, wherein the modified system information block is associated with normal or high priority physical sidelink shared channel transmission.

71. The apparatus of claim 66, wherein the at least one memory and the computer program code are further configured to, with the at least one processor, cause the apparatus at least to:
transmit at least one of a required periodicity, holdover capability, clock accuracy, or required timing accuracy.
